(19) United States
(12) Patent Application Publication
(10) Pub. No.: US 2004/0172487 A1
(43) Pub. Date: Sep. 2, 2004

(54) Method for managing plurality of target computers using a management computer

(76) Inventors: Julio Cesar Arpirez, Alcorcon (Madrid) (ES); Miguel Murillo, Zaragoza (Aragon) (ES)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/375,176

(22) Filed: Feb. 28, 2003

(51) Int. Cl. G06F 3/00

(52) U.S. Cl. 710/8

(57) ABSTRACT

Exemplary embodiments are related to systems and methods for managing a plurality of target computers using a management computer. An exemplary method includes storing parameters for target computers in a memory associated with the management computer. The method includes updating at least one of the parameters at the management computer with a replacement value, and transmitting the replacement value to a selected one of the target computers. The method also includes transmitting a command from the management computer to a selected one of the target computers to initiate execution at the selected target computer of a resident program stored at the selected target computer, where the resident program uses the replacement value.

### RELATED APPLICATIONS

The patent applications “System And Method For Using A Transactional Unit Comprised Of Transactional Subunits”, by Julio Cesar Arpirez Vega, U.S. Ser. No. ______, (Attorney Docket Number 600203544-1) and “Method And System Of Processing An Encapsulated File At A Management Computer”, by Julio Cesar Arpirez Vega, U.S. Ser. No. ______, (Attorney Docket Number 600205142) which are filed concurrently with the present application are incorporated herein by reference.

### BACKGROUND

Management computers, such as servers, can be used to control the operation of a number of target computers. The centralized control of the target computers can simplify the operation of a computer system.

Shell sessions are one way of controlling a target computer from a management computer. A shell session run by the management computer can initiate the execution of resident programs at a target computer. The resident programs may run on differently configured computers. Often, the resident programs at the target computer will access a file of environment variables. When modifications to the target computer are made, an environment variable file can, if necessary, be modified at each target computer. When a change is desired across all of the target computers, the change is separately implemented at each target computer.

### SUMMARY

Methods are disclosed for managing a plurality of target computers using a management computer. An exemplary method includes storing parameters for target computers in a memory associated with the management computer. The method further includes updating at least one of the parameters at the management computer with a replacement value. The method includes transmitting the replacement value to a selected one of the target computers. The method also includes transmitting a command from the management computer to a selected one of the target computers to initiate execution at the selected target computer of a resident program stored at the selected target computer. The resident program uses the replacement value.

An exemplary method for executing a program resident at a target computer includes receiving a first parameter at the target computer from a management computer; receiving at the target computer a first command from the management computer to initiate execution of the resident program; executing the resident program using the first parameter; receiving a replacement parameter at the target computer from a management computer; receiving at the target computer a second command from the management computer to initiate execution of the resident program; and executing a resident program using the replacement parameter.

Exemplary embodiments are directed to a management computer for managing a plurality of target computers. The management computer comprises memory configured to store parameters for the target computers and a processor configured to replace a first parameter in the memory with a replacement parameter. The processor is configured to transmit the replacement parameter to a selected target computer and to transmit a command to the selected target computer to initiate execution at the selected target computer of the resident program stored at the selected target computer. The resident program uses the replacement parameter.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 is a diagram of an exemplary embodiment of a system;

FIG. 2 is a flow chart that illustrates an exemplary method; and

FIG. 3 is a flow chart that illustrates another exemplary method.

### DETAILED DESCRIPTION OF THE PREFERRED EMBODIMENTS

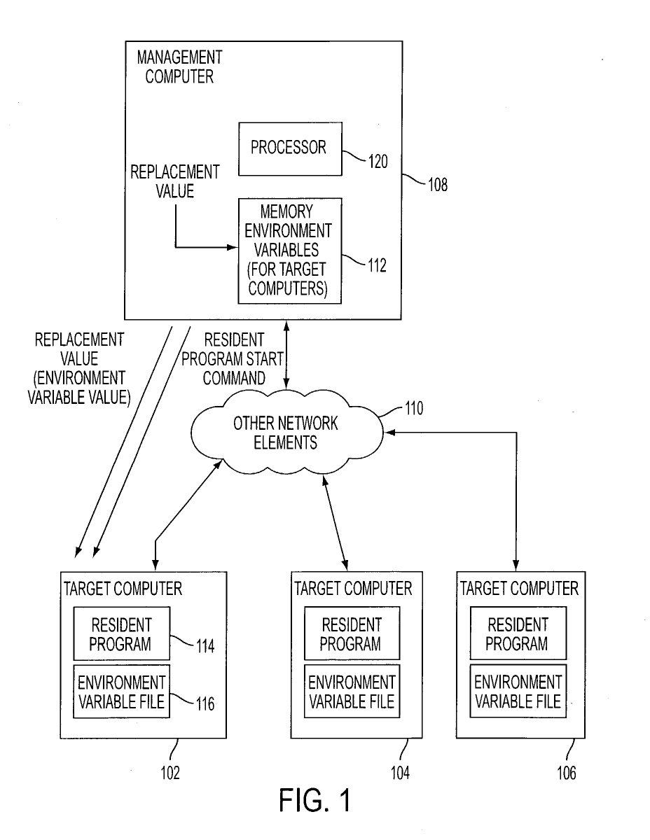

FIG. 1 shows an exemplary method for managing a plurality of target computers, such as target computers 102, 104 and 106, using a management computer, such as management computer 108. The method can be implemented using a computer. A computer-readable medium can contain a program which executes the method for managing a plurality of target computers.

In FIG. 1, the management computer is a server, or any other computer, that is used to control the operation of the target computers 102, 104 and 106. The management computer 108 interacts with the target computers 102, 104 and 106 across other network elements 110. The other network elements 110 can include switches, bridges and the like.

An exemplary method includes storing a parameter (that is, one or more parameters) for a selected target computer in a memory, the memory being associated with the management computer. In the FIG. 1 example, memory 112 is associated with the management computer 108. Separate parameters for each target computer can be stored individually or the same parameters can be provided to any or all of the target computers.

The exemplary method includes updating the parameter at the management computer with a replacement value. In FIG. 1, using the parameter stored in the memory 112, the system can control the operation of resident programs at any selected one or more of the target computers.

In an exemplary embodiment, the replacement value is transmitted to a selected target computer (that is, one or more selected target computers). For example, the replacement value is transmitted to the target computer 102 in FIG. 1. The file location where the replacement value is stored in the memory 112 can be used to determine the target computer to which the replacement value is sent. In an exemplary embodiment, the same replacement value can be sent to more than one target computer.

A command can be transmitted from the management computer to the selected target computer to initiate execution at the selected target computer of a resident program stored at the selected target computer. The resident program, such as resident program 114 of FIG. 1, uses the replacement value. In the FIG. 1 example, the replacement value is stored in memory, such as in environment variable file 116. Because the replacement value can be sent along with the command to start execution, the parameters at the target computers need not to be updated prior to a shell session. The parameters can be updated in the session just before the operation of the resident program.

An exemplary method comprises starting a shell session between the management computer and the selected one target computer. As referenced herein, a shell session is an operation which can allow one or more programs at the target computer, such as the resident program 114, to be executed under control of the management computer, such as the management computer 108.

In an exemplary embodiment, the replacement value transmitting and the command transmitting can be performed within a shell session. Exemplary shell sessions include UNIX shell sessions, DOS shell sessions, and/or any other shell session. The command can be a program run command of the shell session.

The replacement value can be an environment variable value. In one example, name-value pairs for the embodiment variables are stored in the management computer 108. The environment variable values are then transferred to the target computer.

The environment variables for target computers can be stored at the memory associated with the management computer. In FIG. 1, the memory 112 of management computer 108 stores the embodiment variables for the resident programs at the target computer.

The management computer can set the configuration of the target computer by transmitting replacement values. In the example of FIG. 1, the replacement values relate to the configuration of the target computers and by transferring the replacement values to the target computer, the configuration of the target computer can be modified.

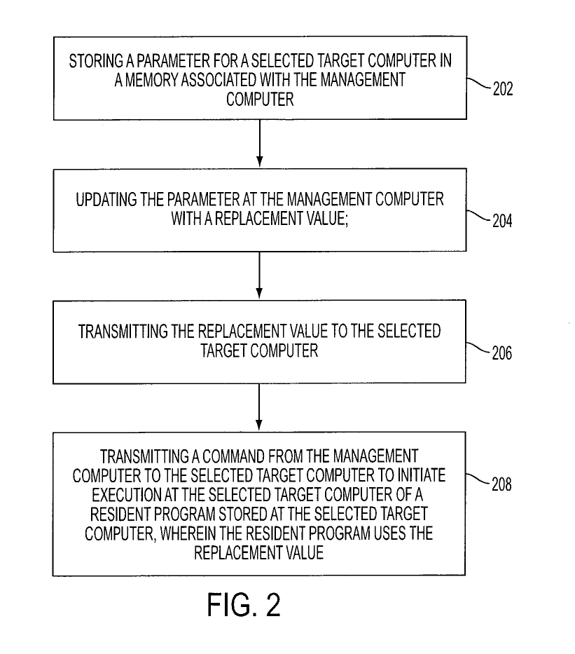

FIG. 2 is an exemplary flow chart. In step 202, parameters for a target computer are stored in a memory associated with the management computer, such as the FIG. 1 memory 112 associated with management computer 101. In step 204 at least one of the parameters at the management computer is updated with a replacement value, such as an environment variable value used to control the configuration of a selected target computer once the parameter is provided to the selected target computer. In step 206, the replacement value is transmitted to the selected target computer. In step 208, a command from the management computer to the selected target computer, is sent to initiate execution of a resident program at the selected target computer using the replacement value.

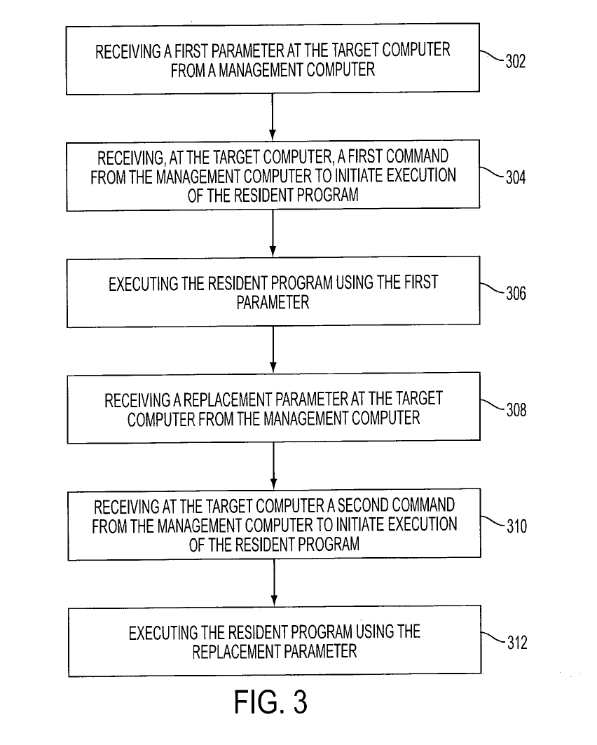

FIG. 3 illustrates an exemplary method for executing a program resident at a target computer. The method can be implemented using a computer. A computer-readable medium can contain a program which executes the method for executing a program resident at a target computer.

An exemplary method as illustrated in FIG. 3 includes receiving a first parameter at the target computer from a management computer in step 302. The method also includes receiving at the target computer a first command from the management computer to initiate execution of the resident program, as illustrated in step 304 of FIG. 3. The resident program is executed using the first parameter in step 306. In step 308, a replacement parameter is received at the target computer from the management computer. In step 310, a second command from the management computer is received at the target computer to initiate execution of the resident program. The resident program is executed at the target computer using the replacement parameter.

In an exemplary embodiment, a shell session can be started between the management computer and the target computers. The replacement value receiving and the command receiving of the FIG. 3 flow chart can be performed within the shell session. In an exemplary embodiment, the replacement value can be an environment variable value stored in memory and can be used to set the configuration of the target computer.

The operation of the resident program can change based upon whether the first value or the replacement value is provided to the target computer. Thus, by providing different values to the target computer, the operation of the system can be modified.

An exemplary embodiment includes a management computer for managing a plurality of target computers. In the FIG. 1 example, management computer 108 can be used for managing a plurality of target computers 102, 104, 106. Memory 112 can be configured to store parameters for the target computers. The management computer can include a processor, such as a processor 120. The processor is configured to replace a first parameter in the memory with the replacement parameter. The processor is configured to transmit the replacement parameter to a selected target computer and to transmit a command from the selected target computer to initiate execution at the selected target computer of the resident program stored at the selected target computer. The resident program can then use the replacement parameter.

In an exemplary embodiment, the processor can be configured to start a shell session between the management computer and the selected target computer. The processor can be configured to transmit the replacement value and the command within the shell session, the replacement value being, for example, an environment variable value. The environment variable values for a target computer can be stored in the memory. In an exemplary embodiment, the processor is configured to transmit a replacement value to the selected target computer.

The presently disclosed embodiments are considered in all respects illustrative and not restrictive. The scope of the methods and systems are indicated by the appended claims rather than the foregoing description and all changes that come within the meaning and range and equivalence thereof are intended to be embraced within.

1. A method for managing a plurality of target computers using a management computer, comprising:
storing a parameter for a selected target computer in a memory associated with the management computer;
updating the parameter at the management computer with a replacement value;
transmitting the replacement value to the selected target computer; and
transmitting a command from the management computer to the selected target computer to initiate execution at the selected target computer of a resident program stored at the selected target computer, wherein the resident program uses the replacement value.

2. The method of claim 1 comprising:
starting a shell session between the management computer and the selected target computer.

3. The method of claim 2, wherein the replacement value transmitting and the command transmitting are performed within the shell session.

4. The method of claim 1, wherein the replacement value is an environment variable value.

5. The method of claim 4, wherein the environment variable value is e stored in the memory associated with the management computer.

6. The method of claim 1, wherein the management computer sets a configuration of the selected target computer by transmitting the replacement value.

7. A method for executing a program resident at a target computer, comprising:
receiving a first parameter at the target computer from a management computer;
receiving, at the target computer, a first command from the management computer to initiate execution of the resident program;
executing the resident program using the first parameter;
receiving a replacement parameter at the target computer from the management computer;
receiving at the target computer a second command from the management computer to initiate execution of the resident program; and
executing the resident program using the replacement parameter.

8. The method of claim 7, comprising:
starting a shell session between the management computer and the target computers.

9. The method of claim 8, wherein the replacement value receiving and the command receiving are performed within the shell session.

10. The method of claim 7, wherein the replacement value is an environment variable value.

11. The method of claim 10, wherein the environment variable values for the target computer is stored in a memory associated with the management computer.

12. The method of claim 7, wherein the management computer sets a configuration of the target computer by transmitting the replacement value.

13. A management computer for managing a plurality of target computers, comprising:
a memory configured to store parameters for the target computers; and
a processor configured to replace a first parameter in the memory with a replacement parameter, to transmit the replacement parameter to a selected target computer and to transmit a command to the selected target computer to initiate execution at the selected target computer of the resident program stored at the selected target computer, the resident program using the replacement parameter.

14. The management computer of claim 13, wherein the processor is configured to start a shell session between the management computer and the selected target computer.

15. The management computer of claim 14, wherein the processor is configured to transmit the replacement value and the command within the shell session.

16. The management computer of claim 13, wherein the replacement value is an environment variable value.

17. The management computer of claim 16, wherein the environment variable values for target computers are stored in the memory.

18. The management computer of claim 13, wherein the processor is configured to set a configuration of the selected target computer by transmitting the replacement value.

19. A system including the management computer of claim 13, the system further including the target computers.

20. A computer readable medium containing a program for managing a plurality of target computers using a management computer, the program comprising:
storing a parameter for a selected target computer in a memory associated with the management computer;
updating the parameter at the management computer with a replacement value;
transmitting the replacement value to the selected target computer; and
transmitting a command from the management computer to the selected target computer to initiate execution at the selected target computer of a resident program stored at the selected target computer, wherein the resident program uses the replacement value.

21. The computer readable medium containing a program of claim 20 comprising:
starting a shell session between the management computer and the selected target computer.

22. The computer readable medium containing a program of claim 21, wherein the replacement value transmitting and the command transmitting are performed within the shell session.

23. The computer readable medium containing a program of claim 20, wherein the replacement value is an environment variable value.

24. The computer readable medium containing a program of claim 23, wherein the environment variable value is stored in the memory associated with the management computer.

25. The computer readable medium containing a program of claim 20, wherein the management computer sets a configuration of the selected target computer by transmitting the replacement value.

26. A computer readable medium containing a program for executing a program resident at a target computer, comprising:
receiving a first parameter at the target computer from a management computer;
receiving, at the target computer, a first command from the management computer to initiate execution of the resident program;
executing the resident program using the first parameter;
receiving a replacement parameter at the target computer from the management computer;
receiving at the target computer a second command from the management computer to initiate execution of the resident program; and
executing the resident program using the replacement parameter.

27. The computer readable medium containing a program of claim 26, comprising:
starting a shell session between the management computer and the target computers.

28. The computer readable medium containing a program of claim 27, wherein the replacement value receiving and the command receiving are performed within the shell session.

29. The computer readable medium containing a program of claim 26, wherein the replacement value is an environment variable value.

30. The computer readable medium containing a program of claim 29, wherein the environment variable values for the target computer is stored in a memory associated with the management computer.

31. The computer readable medium containing a program of claim 26, wherein the management computer sets a configuration of the target computer by transmitting the replacement value.
